(19) United States
(12) Patent Application Publication
(10) Pub. No.: US 2024/0137707 A1
(43) Pub. Date: Apr. 25, 2024

(54) BALANCE STRUCTURE TO INCREASE SPEAKER RATED POWER

(71) Applicant: DELL PRODUCTS L.P., Round Rock, TX (US)

(72) Inventor: Paul Huang, New Taipei City (TW)

(21) Appl. No.: 17/972,480

(22) Filed: Oct. 23, 2022

(51) Int. Cl. H04R 9/06; H04R 9/02

(52) U.S. Cl. CPC H04R 9/06; H04R 9/02

(57) ABSTRACT

A planar speaker for an information handling system includes a frame, a voice coil, a speaker cone, a primary surround damper, and a secondary surround damper. An outside edge of the primary surround damper is affixed to a first surface of the frame, and an inside edge of the primary surround damper is affixed to the cone. An outside edge of the secondary surround damper is affixed to a second surface of the frame, and an inside edge of the secondary surround damper is affixed to a portion of the voice coil.

### FIELD OF THE DISCLOSURE

This disclosure generally relates to information handling systems, and more particularly relates to providing a balance structure to increase the rated power of a speaker in an information handling system.

### BACKGROUND

As the value and use of information continues to increase, individuals and businesses seek additional ways to process and store information. One option is an information handling system. An information handling system generally processes, compiles, stores, and/or communicates information or data for business, personal, or other purposes. Because technology and information handling needs and requirements may vary between different applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, reservations, enterprise data storage, or global communications. In addition, information handling systems may include a variety of hardware and software resources that may be configured to process, store, and communicate information and may include one or more computer systems, data storage systems, and networking systems.

### SUMMARY

A planar speaker for an information handling system may include a frame, a voice coil, a speaker cone, a primary surround damper, and a secondary surround damper. An outside edge of the primary surround damper may be affixed to a first surface of the frame, and an inside edge of the primary surround damper may be affixed to the cone. An outside edge of the secondary surround damper may be affixed to a second surface of the frame, and an inside edge of the secondary surround damper may be affixed to a portion of the voice coil.

### BRIEF DESCRIPTION OF THE DRAWINGS

It will be appreciated that for simplicity and clarity of illustration, elements illustrated in the Figures have not necessarily been drawn to scale. For example, the dimensions of some of the elements are exaggerated relative to other elements. Embodiments incorporating teachings of the present disclosure are shown and described with respect to the drawings presented herein, in which:

FIG. 1 is a block diagram of a planar speaker according to an embodiment of the current disclosure;

FIG. 2 is a top view of a primary surround of the planar speaker of FIG. 1;

FIG. 3 is a top view of a flexible plastic circuit of the planar speaker of FIG. 1;

FIG. 4 is a top view of a secondary surround of the planar speaker of FIG. 1; and

FIG. 5 is a block diagram illustrating a generalized information handling system according to another embodiment of the present disclosure.

The use of the same reference symbols in different drawings indicates similar or identical items.

### DETAILED DESCRIPTION OF DRAWINGS

The following description in combination with the Figures is provided to assist in understanding the teachings disclosed herein. The following discussion will focus on specific implementations and embodiments of the teachings. This focus is provided to assist in describing the teachings, and should not be interpreted as a limitation on the scope or applicability of the teachings. However, other teachings can certainly be used in this application. The teachings can also be used in other applications, and with several different types of architectures, such as distributed computing architectures, client/server architectures, or middleware server architectures and associated resources.

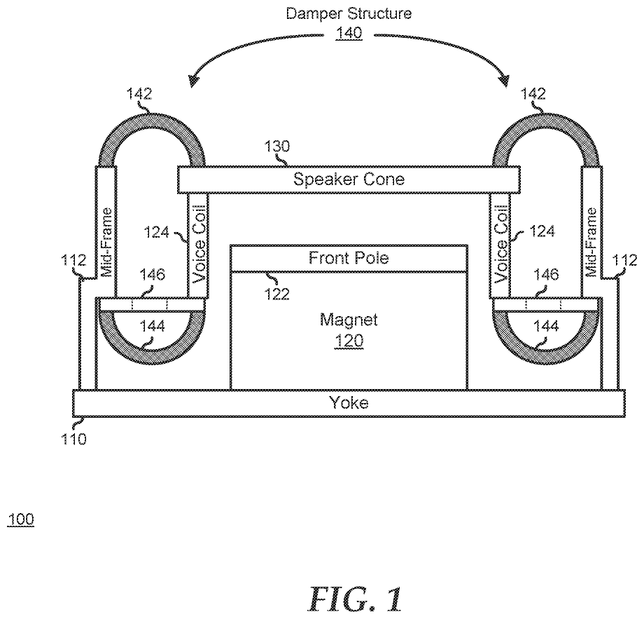

FIG. 1 shows a planar type micro-speaker 100. Planar speakers may typically be found in devices where speaker size and speaker power are limited, such as in a laptop computers, tablet devices, smart phone devices or the like. For example, a planar speaker may typically be rated for peak RMS power levels of around two Watts. On the other hand, external audio amplifiers are typically rated for higher peak RMS power levels of around 10 Watts. Higher power external audio amplifiers are desirable for driving planar speakers because such amplifiers provide higher dynamic range. As such, the power gain of the external audio amplifier is typically reduced when driving a planar speaker. Moreover, as higher peak RMS power levels are driven through the typical planar speaker, the reliably of the lead wires to the voice coil fatigue and become subject to breakage.

Planar speaker 100 includes a yoke 110, a midframe 112, a magnet 120, a front pole 122, a voice coil 124, a speaker cone, 130, and a speaker suspension 140. Yoke 110 and midframe 112 provide the structural housing for the functional elements of planar speaker 100. The functional elements of planar speaker 100 include magnet 120 that is a fixed magnet that is attached to yoke 110, and front pole 122 is attached to the top of the magnet. Voice coil 124 is connected to an audio amplifier to receive an audio signal and operates to vibrate speaker cone 130 in response to the audio signal. Voice coil 134 and speaker cone 130 are flexibly mounted to midframe 112 by speaker suspension structure 140. The details of speaker design and particularly of planar speaker design are known in the art, and will not be further described herein, except as needed to illustrate the current embodiments.

Suspension 140 functions to suspend voice coil 124 within the gap between yoke 110 and magnet 120, and to provide a restoring force to return speaker cone 130 to a neutral position. Suspension 140 includes a primary surround 142, a pair of secondary surrounds 144, and a pair of flexible plastic circuit (FPC) dampers 146. Primary and secondary surrounds 142 and 144 are fabricated of flexible polymer layers, that are typically formed of polyether ether ketone (PEEK) material. As illustrated, primary surround 142 and secondary surrounds 144 are illustrated as including a single layer, but this is not necessarily so, and it will be understood that the primary surround or the secondary surrounds may be fabricated with two or more flexible polymer layers, as needed or desired. In particular, a primary surround such as primary surround 142 may be fabricated to provide the desired mechanical and acoustic properties as deemed necessary to meet the speaker specifications.

A larger number of polymer layers, or thicker polymer in a primary surround will stiffen the suspension structure. Here, a stiffer structure may be provided in order to permit higher peak RMS power operation of the associated loudspeaker. However, such stiffening may have an adverse effect of reducing the dynamic range of the loudspeaker. As such, a number of polymer layers, or the thickness of a primary surround may be selected in order to optimize between the rated power level and the sound quality of the particular loudspeaker. The details of loudspeaker suspension design are known in the art, and will not be further described herein, except as needed to illustrate the current embodiments.

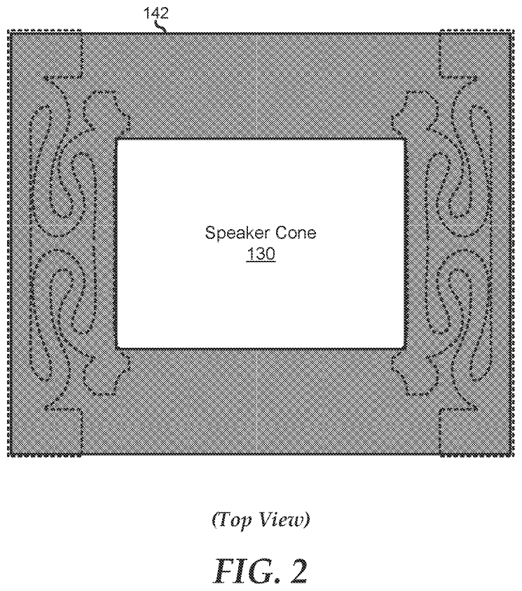

FIG. 2 shows speaker cone 130 and primary surround 142. FPC dampers 146 are illustrated in shadow beneath primary surround 142. Note that primary surround 142 completely surrounds speaker cone 130, thereby sealing the inner elements of planar speaker 100 (for example magnet 120, front pole 122, voice coil 124, secondary surrounds 144, and FPC dampers 146) from the environment outside of the planar speaker. Each one of secondary surrounds 144 is paired with an associated one of FPC dampers 146. Each associated pair of secondary surround 144 and FPC damper 146 are symmetrically mounted at opposite ends of a long axis of planar speaker 100. Henceforth, the description of one associated pair of secondary surround 144 and FPC damper 146 should be understood to apply to the second associated pair of the secondary surround and the FPC damper, unless otherwise indicated. An outer edge of FPC damper 146 mechanically mounts to mid-frame 112 and an inner edge of the FPC damper mechanically mounts to voice coil 124. As such, FPC damper 146 adds to the rigidity and damping of the overall structure of the assembly of voice coil 124, speaker cone 130, and primary damper 142.

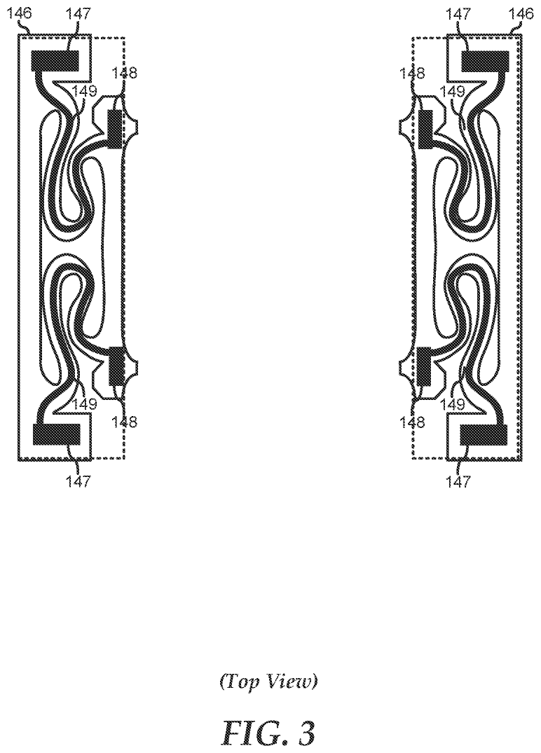

However, in addition to providing rigidity and damping to planer speaker 100, FPC damper 146 provides one or more circuit trace to connect the speaker input to voice coil 124. FIG. 3 illustrates a top view of FPC dampers 146, with secondary surrounds 144 illustrated in shadow below the FPC dampers. Each FPC damper includes at least one circuit that includes an input pad 147, a voice coil pad 148, and a circuit trace 149 that connects the input pad to the voice coil. As such, FPC dampers 146 operate to replace the wire connections between a speaker input and voice coil 124. Four sets of circuit interconnects, two on each FPC damper 146, are illustrated. However a typical voice coil includes represents a single coiled wire with two ends. Thus, in a particular embodiment, only a select two of the circuit interconnects may typically be connected between the speaker inputs and voice coil 124. For example, both circuit interconnects of a particular one of FPC dampers 146 may be utilized to connect the speaker inputs to voice coil 124, or a single circuit interconnect on each one of the FPC dampers may be utilized, as needed or desired. In another embodiment, all four of the circuit interconnects are utilized. In any case, the fabrication of FPC dampers 146 may typically be understood to be common, such that the damping characteristics of the FPC dampers is equivalent between the two FPC dampers.

FPC dampers 146 are fabricated to provide flexibility in the circuit interconnects to minimize the fatigue on the interconnections between the speaker inputs and voice coil 124. In particular, FPC dampers 146 may be fabricated of a flexible base material, such as an insulating material like a polyimide material, a polyester material, a polyethylene naphthalate (PEN) material or the like. Input pad 147, voice coil pad 148, and circuit trace 149 are fabricated on the surface of FPC dampers 146 via any suitable manufacturing method, as needed or desired, such as by processing a solder mask layer, bonding a wire to the surface of the FPC damper, or the like. Secondary surround 144 represents an additional layer of the polymer material that is selectively applied to stiffen suspension 140 to permit operation of micro-speaker 100, without greatly reducing the dynamic range of the micro-speaker.

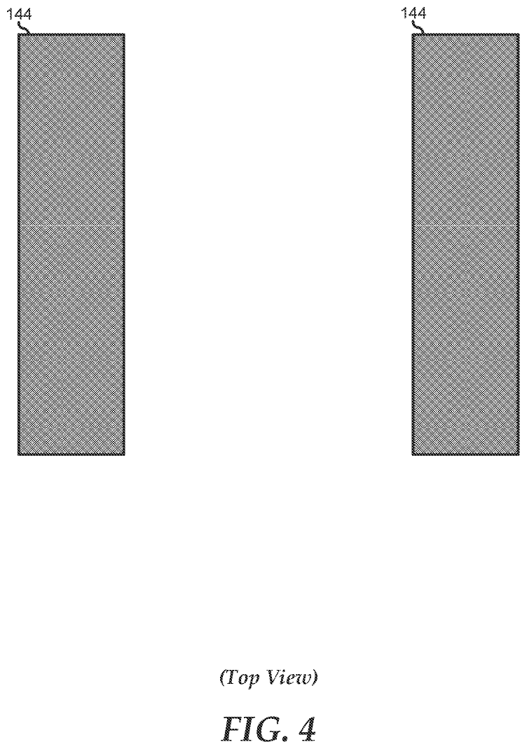

FIG. 4 illustrates secondary surround 144, which may be fabricated as a layer of polymer material that is thinner than the polymer material of primary surround 142, thicker than the primary surround, or the same thickness of as the primary surround, as needed or desired. In this way, a degree of stiffening of suspension 140 can be achieved to any desired degree as needed or desired to achieve a higher dynamic range may. In addition, secondary surround 244 may be fabricated of multiple layers of the polymer material in order to achieve a higher degree of design flexibility to choose between stiffness for higher power level, and dynamic range, as needed or desired. Each one of secondary surrounds 144 has an outer edge portion that corresponds with the outer edge of the associated FPC damper 146, and an inner edge portion that corresponds with the inner edge of the associated FPC damper. The portion of secondary dampers 144 that connects the outer edge portion with the inner edge portion may have an arc-shaped profile, a zig-zag-shaped profile, or he like to offer extra lateral support to voice coil 124 during vibration, permitting fewer rocking modes, and provides increased vertical support to reduce deformation to improve the total harmonic distortion of planar speaker 100.

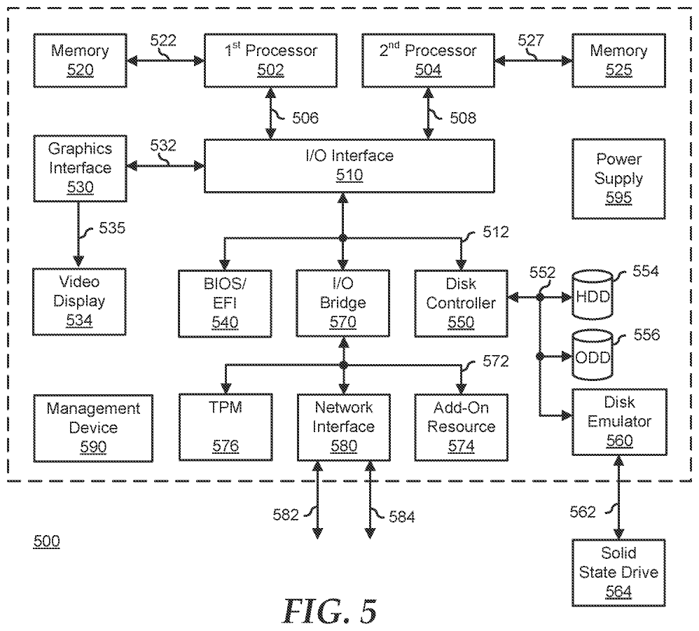

FIG. 5 illustrates a generalized embodiment of an information handling system 500. For purpose of this disclosure an information handling system can include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, information handling system 500 can be a personal computer, a laptop computer, a smart phone, a tablet device or other consumer electronic device, a network server, a network storage device, a switch router or other network communication device, or any other suitable device and may vary in size, shape, performance, functionality, and price. Further, information handling system 500 can include processing resources for executing machine-executable code, such as a central processing unit (CPU), a programmable logic array (PLA), an embedded device such as a System-on-a-Chip (SoC), or other control logic hardware. Information handling system 500 can also include one or more computer-readable medium for storing machine-executable code, such as software or data. Additional components of information handling system 500 can include one or more storage devices that can store machine-executable code, one or more communications ports for communicating with external devices, and various input and output (I/O) devices, such as a keyboard, a mouse, and a video display. Information handling system 500 can also include one or more buses operable to transmit information between the various hardware components.

Information handling system 500 can include devices or modules that embody one or more of the devices or modules described below, and operates to perform one or more of the methods described below. Information handling system 500 includes processors 502 and 504, an input/output (I/O) interface 510, memories 520 and 525, a graphics interface 530, a basic input and output system/universal extensible firmware interface (BIOS/UEFI) module 540, a disk controller 550, a hard disk drive (HDD) 554, an optical disk drive (ODD) 556, a disk emulator 560 connected to an external solid state drive (SSD) 562, an I/O bridge 570, one or more add-on resources 574, a trusted platform module (TPM) 576, a network interface 580, a management device 590, and a power supply 595. Processors 502 and 504, I/O interface 510, memory 520 and 525, graphics interface 530, BIOS/UEFI module 540, disk controller 550, HDD 554, ODD 556, disk emulator 560, SSD 562, I/O bridge 570, add-on resources 574, TPM 576, and network interface 580 operate together to provide a host environment of information handling system 500 that operates to provide the data processing functionality of the information handling system. The host environment operates to execute machine-executable code, including platform BIOS/UEFI code, device firmware, operating system code, applications, programs, and the like, to perform the data processing tasks associated with information handling system 500.

In the host environment, processor 502 is connected to I/O interface 510 via processor interface 506, and processor 504 is connected to the I/O interface via processor interface 508. Memory 520 is connected to processor 502 via a memory interface 522. Memory 525 is connected to processor 504 via a memory interface 527. Graphics interface 530 is connected to I/O interface 510 via a graphics interface 532, and provides a video display output 535 to a video display 534. In a particular embodiment, information handling system 500 includes separate memories that are dedicated to each of processors 502 and 504 via separate memory interfaces. An example of memories 520 and 525 include random access memory (RAM) such as static RAM (SRAM), dynamic RAM (DRAM), non-volatile RAM (NV-RAM), or the like, read only memory (ROM), another type of memory, or a combination thereof.

BIOS/UEFI module 540, disk controller 550, and I/O bridge 570 are connected to I/O interface 510 via an I/O channel 512. An example of I/O channel 512 includes a Peripheral Component Interconnect (PCI) interface, a PCI-Extended (PCI-X) interface, a high-speed PCI-Express (PCIe) interface, another industry standard or proprietary communication interface, or a combination thereof. I/O interface 510 can also include one or more other I/O interfaces, including an Industry Standard Architecture (ISA) interface, a Small Computer Serial Interface (SCSI) interface, an Inter-Integrated Circuit (I²C) interface, a System Packet Interface (SPI), a Universal Serial Bus (USB), another interface, or a combination thereof. BIOS/UEFI module 540 includes BIOS/UEFI code operable to detect resources within information handling system 500, to provide drivers for the resources, initialize the resources, and access the resources. BIOS/UEFI module 540 includes code that operates to detect resources within information handling system 500, to provide drivers for the resources, to initialize the resources, and to access the resources.

Disk controller 550 includes a disk interface 552 that connects the disk controller to HDD 554, to ODD 556, and to disk emulator 560. An example of disk interface 552 includes an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. Disk emulator 560 permits SSD 564 to be connected to information handling system 500 via an external interface 562. An example of external interface 562 includes a USB interface, an IEEE 1394 (Firewire) interface, a proprietary interface, or a combination thereof. Alternatively, solid-state drive 564 can be disposed within information handling system 500.

I/O bridge 570 includes a peripheral interface 572 that connects the I/O bridge to add-on resource 574, to TPM 576, and to network interface 580. Peripheral interface 572 can be the same type of interface as I/O channel 512, or can be a different type of interface. As such, I/O bridge 570 extends the capacity of I/O channel 512 when peripheral interface 572 and the I/O channel are of the same type, and the I/O bridge translates information from a format suitable to the I/O channel to a format suitable to the peripheral channel 572 when they are of a different type. Add-on resource 574 can include a data storage system, an additional graphics interface, a network interface card (NIC), a sound/video processing card, another add-on resource, or a combination thereof. Add-on resource 574 can be on a main circuit board, on a separate circuit board or add-in card disposed within information handling system 500, a device that is external to the information handling system, or a combination thereof.

Network interface 580 represents a NIC disposed within information handling system 500, on a main circuit board of the information handling system, integrated onto another component such as I/O interface 510, in another suitable location, or a combination thereof. Network interface device 580 includes network channels 582 and 584 that provide interfaces to devices that are external to information handling system 500. In a particular embodiment, network channels 582 and 584 are of a different type than peripheral channel 572 and network interface 580 translates information from a format suitable to the peripheral channel to a format suitable to external devices. An example of network channels 582 and 584 includes InfiniBand channels, Fibre Channel channels, Gigabit Ethernet channels, proprietary channel architectures, or a combination thereof. Network channels 582 and 584 can be connected to external network resources (not illustrated). The network resource can include another information handling system, a data storage system, another network, a grid management system, another suitable resource, or a combination thereof.

Management device 590 represents one or more processing devices, such as a dedicated baseboard management controller (BMC) System-on-a-Chip (SoC) device, one or more associated memory devices, one or more network interface devices, a complex programmable logic device (CPLD), and the like, that operate together to provide the management environment for information handling system 500. In particular, management device 590 is connected to various components of the host environment via various internal communication interfaces, such as a Low Pin Count (LPC) interface, an Inter-Integrated-Circuit (I2C) interface, a PCIe interface, or the like, to provide an out-of-band (00B) mechanism to retrieve information related to the operation of the host environment, to provide BIOS/UEFI or system firmware updates, to manage non-processing components of information handling system 500, such as system cooling fans and power supplies. Management device 590 can include a network connection to an external management system, and the management device can communicate with the management system to report status information for information handling system 500, to receive BIOS/UEFI or system firmware updates, or to perform other task for managing and controlling the operation of information handling system 500. Management device 590 can operate off of a separate power plane from the components of the host environment so that the management device receives power to manage information handling system 500 when the information handling system is otherwise shut down. An example of management device 590 includes a commercially available BMC product or other device that operates in accordance with an Intelligent Platform Management Initiative (IPMI) specification, a Web Services Management (WSMan) interface, a Redfish Application Programming Interface (API), another Distributed Management Task Force (DMTF), or other management standard, and can include an Integrated Dell Remote Access Controller (iDRAC), an Embedded Controller (EC), or the like. Management device 590 may further include associated memory devices, logic devices, security devices, or the like, as needed or desired.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A planar speaker for an information handling system, the speaker comprising:
a frame;
a voice coil;
a speaker cone;
a primary surround damper, an outside edge of the primary surround damper affixed to a first surface of the frame, and an inside edge of the primary surround damper affixed to the cone; and
a first secondary surround damper, an outside edge of the first secondary surround damper affixed to a second surface of the frame, and an inside edge of the first secondary surround damper affixed to a first portion of the voice coil.

2. The planar speaker of claim 1, wherein the inside edge of the first primary surround damper is affixed to an entirety of a perimeter of the cone.

3. The planar speaker of claim 2, wherein the inside edge of the first secondary surround damper is affixed to only a first portion of the voice coil.

4. The planar speaker of claim 3, further comprising a second secondary surround damper, an outside edge of the second secondary surround damper affixed to a third surface of the frame, and an inside edge of the second secondary surround damper affixed to a second portion of the voice coil.

5. The planar speaker of claim 4, wherein the third surface of the frame and the second portion of the voice coil are located on opposite sides of the planar speaker on a long axis of the planar speaker from the second surface of the frame and the first portion of the voice coil.

6. The planar speaker of claim 1, wherein the primary surround damper and the first secondary surround damper are formed of a flexible polymer material.

7. The planar speaker of claim 1, further comprising a flexible plastic circuit collocated with the first secondary surround damper.

8. The planar speaker of claim 7, wherein the flexible plastic circuit couples a speaker input of the planar speaker to the voice coil.

9. The planar speaker of claim 8, wherein the flexible plastic circuit is formed of a flexible printed circuit board material.

10. The planar speaker of claim 9, wherein the flexible plastic circuit includes at least one circuit interconnect formed on a surface of the flexible printed circuit board material, and is configured to couple the speaker input to the voice coil.

11. A method comprising:
affixing an outside edge of a primary surround damper of a planar speaker to a first surface of a frame of the planar speaker;
affixing an inside edge of the primary surround damper to a cone of the planar speaker;
affixing an outside edge of a first secondary surround damper to a second surface of the frame; and
affixing an inside edge of the first secondary surround damper to a first portion of a voice coil of the planar speaker.

12. The method of claim 11, wherein the inside edge of the first primary surround damper is affixed to an entirety of a perimeter of the cone.

13. The method of claim 12, wherein the inside edge of the first secondary surround damper is affixed to only a first portion of the voice coil.

14. The method of claim 13, further comprising:
affixing an outside edge of a second secondary surround damper to a third surface of the frame; and
affixing an inside edge of the second secondary surround damper to a second portion of the voice coil.

15. The method of claim 14, wherein the third surface of the frame and the second portion of the voice coil are located on opposite sides of the planar speaker on a long axis of the planar speaker from the second surface of the frame and the first portion of the voice coil.

16. The method of claim 11, wherein the primary surround damper and the first secondary surround damper are formed of a flexible polymer material.

17. The method of claim 1, further comprising collocating a flexible plastic circuit of the planar speaker with the first secondary surround damper.

18. The method of claim 17, further comprising coupling, by the flexible plastic circuit, a speaker input of the planar speaker to the voice coil.

19. The method of claim 18, wherein the flexible plastic circuit is formed of a flexible printed circuit board material, and wherein the flexible plastic circuit includes at least one circuit interconnect formed on a surface of the flexible printed circuit board material, and is configured to couple the speaker input to the voice coil.

20. A planar speaker for an information handling system, the micro-speaker comprising:
a primary surround damper, an outside edge of primary surround damper affixed to a first surface of a frame, and an inside edge of the primary surround damper affixed to a speaker cone;
a first secondary surround damper, an outside edge of the first secondary surround damper affixed to a second surface of the frame, and an inside edge of the first secondary surround damper affixed to a first portion of a voice coil;
a first flexible plastic circuit collocated with the first secondary surround damper;
a second secondary surround damper, an outside edge of the second secondary surround damper affixed to a third surface of the frame, and an inside edge of the second secondary surround damper affixed to a second portion of the voice coil; and
a second flexible plastic circuit collocated with the second secondary surround damper.
